(19) United States
(12) Patent Application Publication
(10) Pub. No.: US 2004/0053628 A1
(43) Pub. Date: Mar. 18, 2004

(54) Radio communications system and method for determining the position of at least one user device

(76) Inventor: Mark Beckman, Braunschweig (DE)

Correspondence Address: BELL, BOYD & LLOYD, LLC, P. O. BOX 1135, CHICAGO, IL, 60690-1135, US

(21) Appl. No.: 10/466,784

(22) PCT Filed: Jan. 7, 2002
(86) PCT No.: PCT/DE02/00018

(30) Foreign Application Priority Data
Jan. 17, 2001 (DE) 101-01-969.6

(51) Int. Cl. H04M 1/00

(52) U.S. Cl. 455/456.2; 455/456.1; 455/404.2; 455/67.11

(57) ABSTRACT

A method is provided for determining the position of at least one user device of a radio communications system. According to the method, in response to a request signal, one or more message signals is/are exchanged between the radio network controller that is allocated to the base station of the location radio cell of the respective user device to be located and at least one additional position calculation unit, in such that a positional calculation for the respective user device that is to be located can be carried out in the radio network.

### BACKGROUND OF THE INVENTION

In a radio communications system, such as a radio communications system which conforms to the UMTS (universal mobile telecommunication system) standard, it may, in practice, be of interest to selectively determine the current position or location of a specific user device; in particular, of a mobile radio communication device.

For example, from U.S. Pat. No. 5,929,806, a location calculation method for this is known wherein the runtimes of signals from the respective mobile device to be located are determined in at least two fixed transceiver or base stations in relation to a common time base. These base stations are connected via a network to a locating processor which carries out the location calculation for the mobile device to be located. The location calculation then can be sent to an infrastructural unit of the network.

From U.S. Pat. No. 6,070,078, a cellular telephone having a functionally reduced GPS receiver and whose locational position is to be determined is known. To this end, auxiliary information is calculated by a server in the base station of the locating radio cell of the cellular telephone to be located. The server receives GPS-ephemerides information from a fully functional GPS receiver in the base station or alternatively from a GPS receiver of a data service via a radio network connected to the base station.

An object of the present invention is to indicate a way in which in a radio communications system determination of the position of a specific user device can be carried out in a simple and reliable manner in the radio network.

### SUMMARY OF THE INVENTION

Accordingly, a method is provided for determining the position of at least one user device of a radio communications system which has a large number of base stations in associated radio cells, wherein at least one radio network controller is, in each case, allocated to a predefinable group of base stations for coordination purposes, wherein, in response to at least one request signal for determining the position of the respective user device to be located by the radio network controller which is allocated to the base station of the location radio cell of the respective user device to be located, assistance data is requested from at least one position calculation unit as a further additional network unit for determining the position with the aid of one or more message signals which contain information as to when assistance data is to be sent for the first time from the position calculation unit to the radio network controller, and/or contain a time when the position calculation unit is no longer to send any assistance data to the radio network controller, and/or which contain a periodicity indication from which the position calculation unit can see that it can send assistance data regularly to the radio network controller.

Because at least one message signal is exchanged between the respective radio network controller responsible and at least one position calculation unit as an additional network unit of the radio network with this type of information on assistance data for determining the position, the specific position of the respective user device to be located can be determined in the radio network in a simple, reliable and faster manner.

The present invention also relates to a radio communications system which is capable of implementing the method according to the present invention.

Additional features and advantages of the present invention are described in, and will be apparent from, the following Detailed Description of the Invention and the Figures.

### BRIEF DESCRIPTION OF THE FIGURES

FIG. 1 shows in diagrammatic representation the signaling of messages between a user device to be located, a radio network controller and an additional position calculation unit of a radio communications system for implementing the method according to the present invention.

FIG. 2 shows in diagrammatic representation the hierarchical structure of the radio communications system with the various components according to FIG. 1.

FIG. 3 shows in diagrammatic representation the additional connection of the position calculation unit according to FIG. 1 to the radio network controller responsible in the particular case.

### DETAILED DESCRIPTION OF THE INVENTION

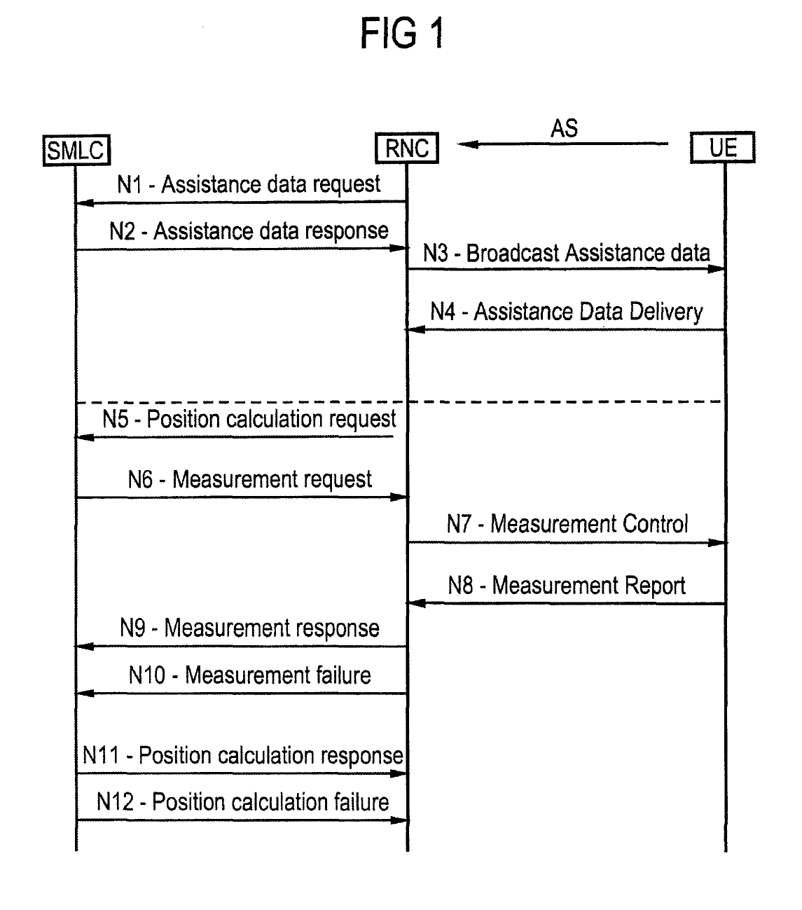

A service which is offered in a mobile radio communication system, particularly a system which conforms to the UMTS (universal mobile telecommunication system) standard, is the location service. Here, the position of a mobile radio communication terminal or user device UE (=user equipment) is determined. One of the possible methods for determining a position is the assisted GPS method. Here, the respective mobile radio communication terminal to be located is equipped with a GPS (global positioning system) receiver and measures signals which are emitted by satellites. The precise method for determining a position is not of interest for the present invention. Under the UMTS standard, a distinction is made between a UE-assisted method and a UE-based method. In the case of the UE-assisted method, the positional calculation is carried out in the network of the radio communications system. In the case of the UE-based method, the positional calculation is carried out in the respective user device UE itself that is to be located. In order to enable a position to be determined more rapidly, assistance data is transmitted to the respective user device UE to be located for the assisted GPS method. This assistance data is obtained by the network from a reference GPS receiver, which has been omitted in FIGS. 1 to 3 here for the sake of clarity.

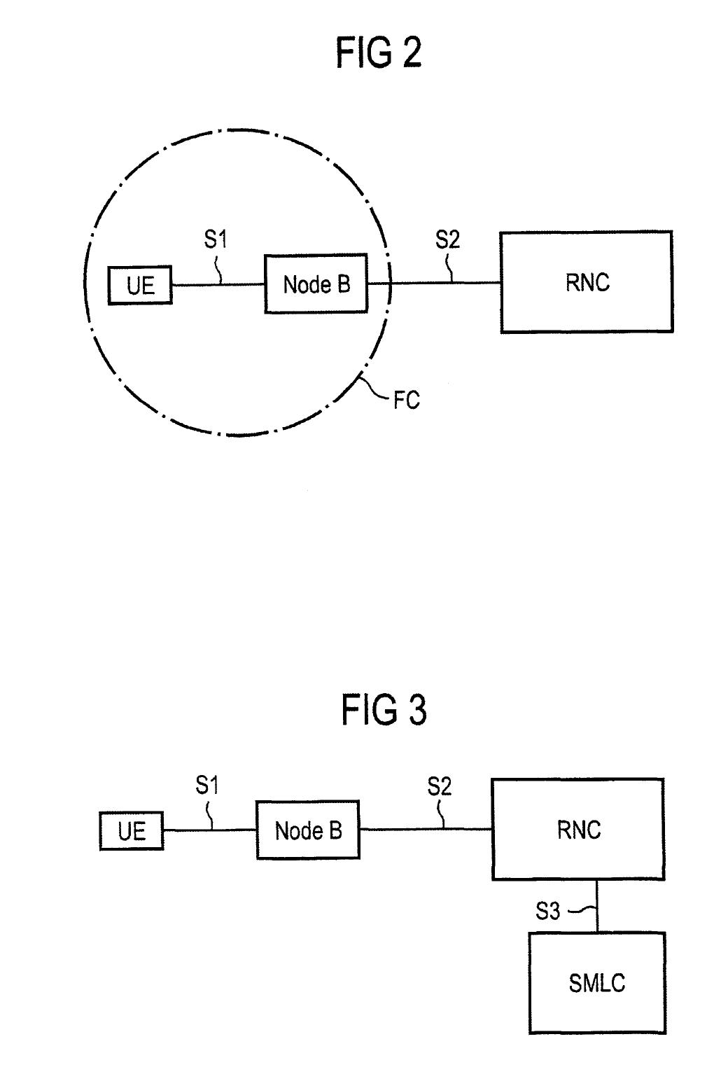

The present embodiment is, for the sake of simplicity, concerned only with the UE-assisted GPS method, by which the position of the respective user device to be located is calculated in the network. According to FIG. 1, the user device UE to be located is connected via an air interface S1 to a base station NodeB, which, in turn, is connected via a fixed-network connection S2 to the radio network controller RNC. Thus, FIG. 2 shows a part of a radio communications system which otherwise has a large number of base stations (such as, e.g., NodeB) in associated radio cells FC, at least one radio network controller (RNC) being allocated for coordination purposes to one predefinable group of base stations (NodeB).

In response to at least one request signal AS for determining the position of the respective user device UE, one or more message signals are then exchanged between the radio network controller which is allocated to the base station (such as, e.g., NodeB) of the location radio cell FC of the respective user device to be located (such as, e.g., UE) and at least one additional position calculation unit (such as, e.g., SMLC) (see FIG. 3) in such a way that a positional calculation for the respective user device UE to be located can be carried out in the radio network.

In detail, for the UE-assisted GPS method for determining a position, the radio network controller RNC sends one or more message signals (assistance data) via the air interface either to all user devices of a radio cell (broadcast) or to a single specific user device such as (such as, e.g., UE). If the position of the respective user device is to be determined, the radio network controller RNC sends a message N7 (measurement control) to the user device whose position is to be determined and requests it to make GPS measurements. The user device such as (such as, e.g., UE) then sends the measurement results N8 (measurement report) back to the radio network controller RNC which then calculates the position from these.

In order to make a positional calculation in the network, an open interface S3 is now provided between the radio network controller RNC responsible and another additionally introduced, preferably external, network unit SMLC (serving mobile location center). The task of the SMLC is to carry out the calculation of the position for the respective user device to be located (see FIG. 3). To this end, an exchange of message is implemented between the position calculation unit SMLC and the radio network controller RNC, and the information needed in the messages, which enables a positional calculation to be made by the position calculation unit SMLC, is subsequently examined.

In detail, the radio network controller RNC, with the aid of a message N1, an assistance data request, requests assistance data from the position calculation unit SMLC in order to then distribute the data to all UEs (broadcasting). This message also may contain useful information as to when assistance data is to be sent for the first time to the radio network controller and/or a time when the GPS SMLC is no longer to send assistance data to the RNC. In addition, the message N1 preferably may contain a periodicity instruction from which the position calculation unit SMLC can see that it can send the assistance data regularly. To this end, the position calculation unit SMLC receives, in particular, the additional functionality for sending assistance data regularly to the RNC.

Furthermore, this assistance data is usefully delivered from the position calculation unit SMLC via a message N2 “Assistance Data Response” to the radio network controller RNC.

The radio network controller RNC also may inform the position calculation unit SMLC via a message N5 “Position Calculation Request” that this position calculation unit is to determine the position of a requested user device. To this end, this message preferably contains an identification of the user device whose position is to be determined. It also may be useful if the message contains information with which the radio network controller RNC informs the position calculation unit SMLC that the radio network controller RNC needs assistance data. This is particularly advantageous if the RNC distributes the assistance data not to all user devices of the respective radio cell in which the user device UE whose position is to be determined is located. Furthermore, the message optionally may specify a time when the RNC last received assistance data. This is particularly advantageous since the position calculation unit SMLC can then decide whether the assistance data has changed since the last time and, if this is the case, send only the assistance data which has changed since the last time. Furthermore, it may be useful for the respective radio network controller RNC responsible to forward the last measurements received from the respective user device UE to be located and the time when these were carried out to the position calculation unit SMLC. This is particularly advantageous since the GPS SMLC can then decide whether the data is sufficiently up-to-date and can already determine the position.

Furthermore, the message optionally may contain information as to how precisely the position is to be determined. In addition, the massage can contain useful information about the starting point, end point and periodicity. This is particularly advantageous since, in this way, it may be made possible for the position calculation unit SMLC to determine the position in a specified period or else with unlimited regularity.

Finally, the message optionally also may contain information about the way in which the result (e.g., area, or point with an inaccuracy) is to be forwarded to the radio network controller RNC responsible.

With the aid of the message N6 “Measurement Request”, the position calculation unit SMLC can request the radio network controller RNC firstly to deliver with the aid of the existing measurement procedures the assistance data to the user device UE and to request it to carry out GPS measurements. With the aid of this message, the position calculation unit SMLC also can deliver the assistance data to the radio network controller RNC. Furthermore, the message may contain, in particular, an identification of the user device UE to be located whose position is to be determined.

After the radio network controller RNC has received the GPS measurement results from the user device UE, the radio network controller RNC delivers the results with the aid of a message N9 “Measurement Response” to the position calculation unit SMLC.

If the radio network controller RNC cannot deliver any GPS measurement results, it sends a message N10 “Measurement Failure” to the position calculation unit SMLC. This message preferably contains an identification of the user device in respect of which no GPS measurement results were able to be delivered. Furthermore, the message usefully contains information about the reason why the measurement results could not be delivered. Possible reasons may be, for example, “too little assistance data,” “no results received from UE” and “UE not known to RNC.” This is particularly advantageous because the position calculation unit SMLC thus knows the reason for the failure and can respond to it. If, for example, the reason is “too little assistance data”, the position calculation unit SMLC can deliver more assistance data with the next “Measurement Request” message N6.

If the GPS measurement results were able to be delivered to the position calculation unit SMLC, and the position calculation unit was able to determine or calculate the position with the accuracy desired, it then sends a message N11 “Position Calculation Response” to the radio network controller RNC, in which message the position and an indication of the accuracy with which the position was able to be determined are contained. The message also preferably contains an identification of the user device UE to be located. The message also may contain a time statement indicating when the position has been determined.

If the position could not be determined, the GPS position calculation unit SMLC usefully sends a message N12 “Position Calculation Failure” to the RNC. This message preferably contains an indication of the user device UE whose position could not be determined. A reason for the failure to determine the position also is usefully contained in the message. The following reasons preferably may be communicated: “Inadequate measurement results,” “Position could not be determined with desired accuracy.” This is particularly advantageous since the radio network controller RNC may then start the procedure once again and may eliminate possible reasons for the fault. In the event that the position cannot be determined with the accuracy desired, it may be useful to add to the message the position determined and the accuracy with which it could be determined. This is particularly advantageous since the radio network controller RNC may then decide whether it would nevertheless like to use the results.

Although the present invention has been described with reference to specific embodiments, those of skill in the art will recognize that changes may be made thereto without departing from the spirit and scope of the present invention as set forth in the hereafter appended claims.

13 (new): A method for determining a position of at least one user device of a radio communications system which has a plurality of base stations in associated radio cells, wherein at least one radio network controller is respectively allocated to a predefinable group of the base stations for coordination purposes, the method comprising the steps of:
sending at least one request signal for determining the position of the respective user device to be located by the radio network controller which is allocated to the base station of a location radio cell of the respective user device to be located; and
requesting assistance data for determining the position from at least one position calculating unit as a further additional network unit with the aid of at least one first message signal which contains at least one of (a) information regarding when the assistance data is to be sent for a first time from the position calculation unit to the radio network controller, (b) a time when the position calculation unit is no longer to send any assistance data to the radio network controller, and (c) a periodicity instruction from which the position calculation unit can see that it can send assistance data regularly to the radio network controller.

14 (new): A method for determining a position of at least one user device of a radio communications system as claimed in claim 13, wherein the determination of the position is carried out in at least one of a UMTS, a GPRS, and an EDGE radio communications system.

15 (new): A method for determining a position of at least one user device of a radio communications system as claimed in claim 13, wherein the user device is a mobile radio communications device.

16 (new): A method for determining a position of at least one user device of a radio communications system as claimed in claim 13, wherein, in the at least one first message signal sent from the radio network controller to the position calculation unit, a time is specified when the radio network controller last received assistance data from the position calculation unit.

17 (new): A method for determining a position of at least one user device of a radio communications system as claimed in claim 16, wherein the assistance data which has changed since the last time is sent from the position calculation unit to the radio network controller.

18 (new): A method for determining a position of at least one user device of a radio communications system as claimed in claim 13, wherein, with the aid of the at least one first message signal sent from the radio network controller to the position calculation unit, information is communicated to the position calculation unit as to how precisely the position of the respective user device to be located is to be determined.

19 (new): A method for determining a position of at least one user device of a radio communications system as claimed in claim 12, wherein, with the aid of the at least one first signal sent from the radio network controller to the position calculation unit, information is communicated to the position calculation unit about an identity of the respective user device to be located.

20 (new): A method for determining a position of at least one user device of a radio communications system as claimed in claim 12, wherein the radio network controller is requested by the position calculation unit with the aid of a second message to send a third message with assistance data to the respective user device to be located.

21 (new): A method for determining a position of at least one user device of a radio communications system as claimed in claim 12, wherein the radio network controller is requested by the position calculation unit with the aid of a second message to send a third message to the respective user device to be located with the request that the user device carry out GPS measurements.

22 (new): A method for determining a position of at least one user device of a radio communications system as claimed in claim 21, wherein GPS measurement results are sent back from the respective user device to be located to the radio network controller, and the GPS measurement results are delivered by the radio network controller to the position calculation unit with the aid of a fourth message.

23 (new): A method for determining a position of at least one user device of a radio communications system as claimed in claim 12, wherein, with the aid of the position calculation unit, a positional calculation for the respective user device to be located is carried out in the radio network in accordance with a UE-assisted method of UMTS.

24 (new): A radio communications system with for determining a position of at least one user device in the radio communications system, comprising:
a plurality of base stations in associated radio cells;
at least one radio network controller respectively allocated to a predefinable group of the base stations for coordination purposes; and
at least one position calculation unit as a further additional network unit;
wherein at least one request signal is sent for determining the position of the respective user device to be located by the radio network controller which is allocated to the base station of the location radio cell of the respective user device to be located, and wherein assistance data for determining the position is requested from the at least one position calculation unit with the aid of at least one first message signal which contains at least one of (a) information regarding when the assistance data is to be sent for a first time from the position calculation unit to the radio network controller, (b) a time when the position calculation unit is no longer to send any assistance data to the radio network controller, and (c) a periodicity instruction from which the position calculation unit can see that it can send assistance data regularly to the radio network controller.
